(19) United States
(12) Patent Application Publication
(10) Pub. No.: US 2006/0085653 A1
(43) Pub. Date: Apr. 20, 2006

(54) Method and system for transferring data with respect to a portable electronic device

(75) Inventors: Steven Bollinger, San Jose, CA (US); Ken Herman, San Jose, CA (US); Michael Cornwell, San Jose, CA (US)

Correspondence Address: BEYER WEAVER & THOMAS LLP, P.O. BOX 70250, OAKLAND, CA, 94612-0250, US

(73) Assignee: Apple Computer, Inc.

(21) Appl. No.: 10/961,571

(22) Filed: Oct. 8, 2004

(51) Int. Cl. G06F 1/26

(52) U.S. Cl. 713/300

(57) ABSTRACT

Improved techniques for performing data transfer with respect to a portable electronic device are disclosed. The improved techniques enable the rate of data transfer to be dependent on at least one battery attribute of a battery utilized by the portable electronic device. As an example, the at least one battery attribute can be associated with a charge level of the battery. In one embodiment, when the charge level of the battery is deemed low, the rate of data transfer can be restricted, thereby reducing the rate of power consumption. Typically, data transfer is performed between the portable electronic device and a host device via a cable. The cable also provides power from the host device to the portable electronic device. Hence, by reducing the rate of data transfer when the charge level of the battery is low, power consumption of the portable electronic device can be controlled so that it is not more than the amount of power capable of being supplied to the portable electronic device over the cable. The portable electronic device can, for example, be a portable data storage device (e.g., portable disk drive) or a portable media device (e.g., portable media player).

### BACKGROUND OF THE INVENTION

1. Field of the Invention

The present invention relates to portable electronic devices and, more particularly, to data transfer with portable electronic devices, such as portable media players.

2. Description of the Related Art

Synchronization operations have been conventionally performed between portable devices, such as Personal Digital Assistants (PDAs) and host computers, to synchronize electronic files or other resources. For example, these files or other resources can pertain to text files, data files, calendar appointments, emails, to-do lists, electronic rolodexes, etc.

In the case of media players, such as MP3 players, files are typically moved between a host computer and a media player through use of a drag and drop operation, like is conventionally done with respect to copying of a data file from a Windows desktop to a floppy disk. Hence, the user of the media player manually initiates the synchronization for individual media items. As a consequence, synchronization tends to be tedious and time consuming for users. More recently, media players have been able to be synchronized with a host computer when a bus connection over a cable is made. Here, the synchronization can be automatically initiated when the cable is connected between the host computer and the media player. The iPod® offered by Apple Computer, Inc. of Cupertino, Calif. has the capability to provide such synchronization over a cable.

A media player is normally portable, battery-powered media device. However, when the media player is connected to a host computer by a bus connection over a cable, power can also be supplied to the media player by way of the cable. For example, when the bus connection is a FIREWIRE connection or a USB connection, power is available to be supplied to the media player over the bus connection. However, the available power from the bus connection is limited by the associated bus standard. The available power from the bus connection can be used by the media player to perform various operations. Recently, such power from the bus connection has been used to charge the battery utilized by the media player. However, when the battery is at a low capacity, and the media player is consuming significant power due to its performance of operations, the available power from the bus connection can be consumed by the media player's performance of operations. In such case, the battery is not able to be charged and can operate in a negative charge environment. In the negative charge environment, the battery's charge is being drained because the power consumed by the media player while performing various operations exceeds the power available over the bus connection. This is particularly problematic when the battery charge level is low. While such negative charge environment can be tolerated for some unknown period of time, if the media player's operations continue, the battery can eventually be fully drained in which case the media player would fail.

Thus, there is a need for improved techniques to manage power consumption on a media player so that reliable extended operation can be achieved.

### SUMMARY OF THE INVENTION

Broadly speaking, the invention relates to improved techniques to perform data transfer with respect to a portable electronic device. The improved techniques enable the rate of data transfer to be dependent on at least one battery attribute of a battery utilized by the portable electronic device. As an example, the at least one battery attribute can be associated with a charge level of the battery. In one embodiment, when the charge level of the battery is deemed low, the rate of data transfer can be restricted, thereby reducing the rate of power consumption. Typically, data transfer is performed between the portable electronic device and a host device via a cable. The cable also provides power from the host device to the portable electronic device. Hence, by reducing the rate of data transfer when the charge level of the battery is low, power consumption of the portable electronic device can be controlled so that it is not more than the amount of power capable of being supplied to the portable electronic device over the cable.

The invention pertains to portable electronic devices that are powered by an internal battery and/or a peripheral bus connection with a host device. As examples, the portable electronic devices can be portable data storage devices (e.g., portable disk drives) or, more particularly, portable media devices. A portable media device, such as a portable media player, is typically capable of storing and playing media items as well as receiving (transferring) media items over a peripheral bus connection with a host device (e.g., personal computer).

The invention can be implemented in numerous ways, including as a method, system, device, apparatus, or computer readable medium. Several embodiments of the invention are discussed below.

As a method for transferring data to or from a portable electronic device, where the portable electronic device is capable of storing data, and where the portable electronic device is powered by a battery within the portable electronic device and/or a wired bus connected to a host computer, one embodiment of the invention includes at least the acts of: evaluating a battery charge level for the battery; and controlling a data transfer rate for data items with respect to the portable electronic device based on the battery charge level.

As a method for transferring data to or from a portable media device, where the portable media device is capable of storing and playing media items, and where the portable media device is powered by a battery within the portable media device and/or a wired bus connected to a host computer, another embodiment of the invention includes at least the acts of: receiving a data transfer request at the portable media device from a host device, where the data transfer requests transfer of at least one block of data; performing transfer of the at least one block of data to or from the portable media player; determining whether a battery charge level for the battery is low; imposing a delay when the determining determines that the battery charge level is low; and subsequently informing the host computer that the transfer of the block of data has completed.

As a media device, one embodiment of the invention includes at least: a media store for storing media items; a communication interface for interfacing with a host device via a cable that provides media data and power to the media device when the cable is connected between the media device and the host device; and a battery for providing power to the media device. Further, media data can be transferred between the host device and the media store via the communication interface. The rate of the transfer of the media data can also be slowed so that the power provided via the cable to the media device is adequate to power the media device during the transfer of the media data without assistance from the battery.

As a media device, another embodiment of the invention includes at least: a media store for storing media items; a communication interface for interfacing with a host device via a cable that provides media data and power to the media device when the cable is connected between the media device and the host device; a battery for providing power to the media device; and a battery monitor that monitors a battery attribute of the battery. Further, media data can be transferred between the host device and the media store via the communication interface. The rate of the transfer of the media data is controlled based on the battery attribute of the battery as monitored by the battery monitor.

As a computer readable medium including at least computer program code for transferring data to or from a portable media device, where the portable media device is capable of storing and playing media items, and where the portable media device is powered by a battery within the portable media device and/or a bus connected to a host computer, one embodiment of the invention includes at least: computer program code for evaluating a battery charge level for the battery; and computer program code for controlling a data transfer rate for media items with respect to the portable media device based on the battery charge level.

As a computer readable medium including at least computer program code for transferring data to or from a portable electronic device, where the portable electronic device is capable of storing data items, and where the portable electronic device is powered by a battery within the portable electronic device and/or a bus connected to a host computer, another embodiment of the invention includes at least: computer program code for receiving a data transfer request at the portable electronic device from a host device, the data transfer requesting transfer of at least one block of data; computer program code for performing transfer of the at least one block of data to or from the portable electronic player; computer program code for determining whether a battery charge level for the battery is low; computer program code for imposing a delay when it is determined that the battery charge level is low; and computer program code for subsequently informing the host computer that the transfer of the block of data has completed.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram of a data transfer process according to one embodiment of the invention.

FIG. 2 is a flow diagram of a media device data access process according to one embodiment of the invention.

FIG. 3 is a flow diagram of a host data transfer process according to one embodiment of the invention.

FIG. 4 is a block diagram of a media device according to one embodiment of the invention.

FIG. 5 is a block diagram of a media management system according to one embodiment of the invention.

FIG. 6 is a block diagram of a media player according to one embodiment of the invention.

### DETAILED DESCRIPTION OF THE INVENTION

The invention relates to improved techniques to perform data transfer with respect to a portable electronic device. The improved techniques enable the rate of data transfer to be dependent on at least one battery attribute of a battery utilized by the portable electronic device. As an example, the at least one battery attribute can be associated with a charge level of the battery. In one embodiment, when the charge level of the battery is deemed low, the rate of data transfer can be restricted, thereby reducing the rate of power consumption. Typically, data transfer is performed between the portable electronic device and a host device via a cable. The cable also provides power from the host device to the portable electronic device. Hence, by reducing the rate of data transfer when the charge level of the battery is low, power consumption of the portable electronic device can be controlled so that it is not more than the amount of power capable of being supplied to the portable electronic device over the cable.

The invention pertains to portable electronic devices that are powered by an internal battery and/or a peripheral bus connection with a host device. As examples, the portable electronic devices can be portable data storage devices (e.g., portable disk drives) or, more particularly, portable media devices. A portable media device, such as a portable media player, is typically capable of storing and playing media items as well as receiving (transferring) media items over a peripheral bus connection with a host device (e.g., personal computer). Although the invention is further described below with reference to media devices, it should be understood that the invention is applicable to other types of portable electronic device besides media devices.

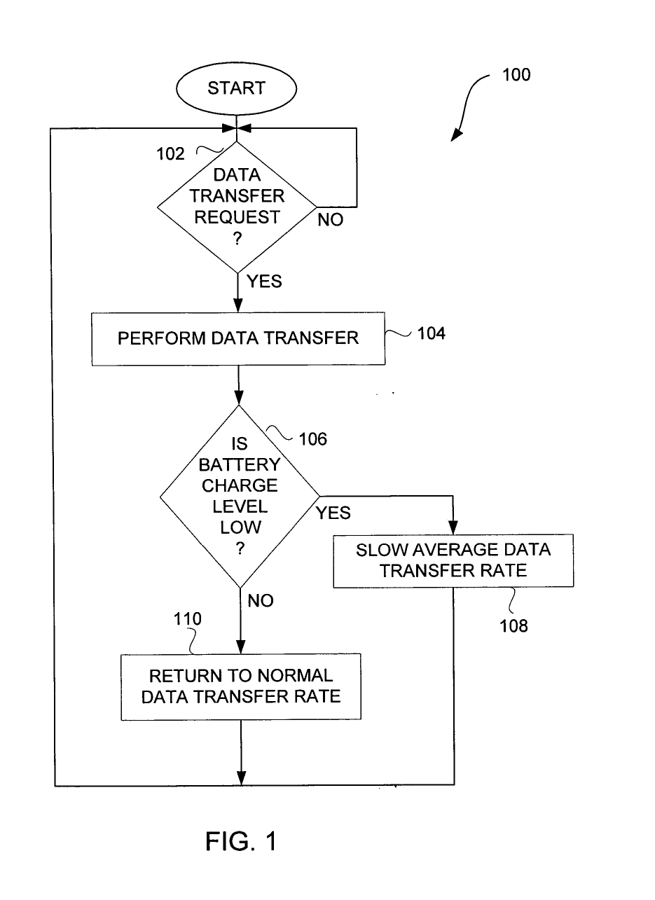

Embodiments of the invention are discussed below with reference to FIGS. 1-6. However, those skilled in the art will readily appreciate that the detailed description given herein with respect to these figures is for explanatory purposes as the invention extends beyond these limited embodiments.

FIG. 1 is a flow diagram of a data transfer process 100 according to one embodiment of the invention. The data transfer process 100 is, for example, performed by a media device, such as a media player.

The data transfer process 100 begins with a decision 102 that determines whether a data transfer request has been received. When the decision 102 determines that a data transfer request has not been received, the data transfer process 100 awaits such a request. However, once the decision 102 determines that a data transfer request has been received, data transfer is performed 104. The data transfer concerns the transfer of data to or from the media device in accordance with the data transfer request.

A decision 106 then determines whether a battery charge level is low. The battery charge level pertains to a charge level of a battery of the media device. When the decision 106 determines that the battery charge level is low, then an average data transfer rate for the media device is slowed 108. Here, the average data transfer rate is slowed so that the power consumed by the media device is reduced. If the data transfer rate is already at the slow data transfer rate, the data transfer rate merely remains at the slow data transfer rate. By slowing the average data transfer rate, the media device consumes energy at a slower rate, thereby reducing power consumption. As a trade-off, the data transfer process may take an additional amount of time to complete given that the data transfer rate has been slowed.

Alternatively, when the decision 106 determines that the battery charge level is not low, then the media device can operate in accordance with a normal data transfer rate. Hence, the data transfer process 100 indicates that the data transfer rate returns 110 to its normal rate. Of course, if the data transfer rate is already at the normal data transfer rate, the data transfer rate merely remains at the normal data transfer rate.

Following the operations 108 and 110, the data transfer process 100 returns to repeat the decision 102 and subsequent blocks so that subsequent data transfer requests can be similarly processed.

Accordingly, in one embodiment of the invention, the data transfer rate is dependent upon the battery charge level. In cases in which the battery charge level is low, the average data transfer rate for the media device is reduced, thereby slowing the rate by which energy is consumed by the media device. Typically, during data transfer, a media device is connected by a cable to a host device. The host device transfers data pertaining to media items via the cable. The host device also provides a limited amount of power to the media device via the cable. That is, the amount of power available over the cable is limited. For example, the cable can be a USB cable and have a limit of 2.5 Watts. However, it is not uncommon for the amount of power available from the cable to be exceeded by the demands of media device. For example, a media device performing operations might require 3.0 Wafts or more. In such cases, the battery is called upon to provide supplemental power for the operations being performed by the media device. As an example, the operations can pertain to data transfer between the host computer and the media device. Often, such data transfers can involve numerous media items and thus take a considerable amount of time and power to complete. In such cases, the battery may lose all significant charge. Such is particularly problematic when the battery charge level is low and/or the amount of data to be transferred is substantial.

According to one embodiment of the invention, if the battery charge level is deemed low, the average data transfer rate is slowed so that the power available over the cable is adequate to power the media device in the data transfer operation. On the other hand, when the battery charge level is not low, the average data transfer rate is not slowed. Moreover, if the average data transfer rate was previously slowed but now the battery charge level is no longer low (such as through charging of the battery), the data transfer rate can be returned 110 to its normal rate.

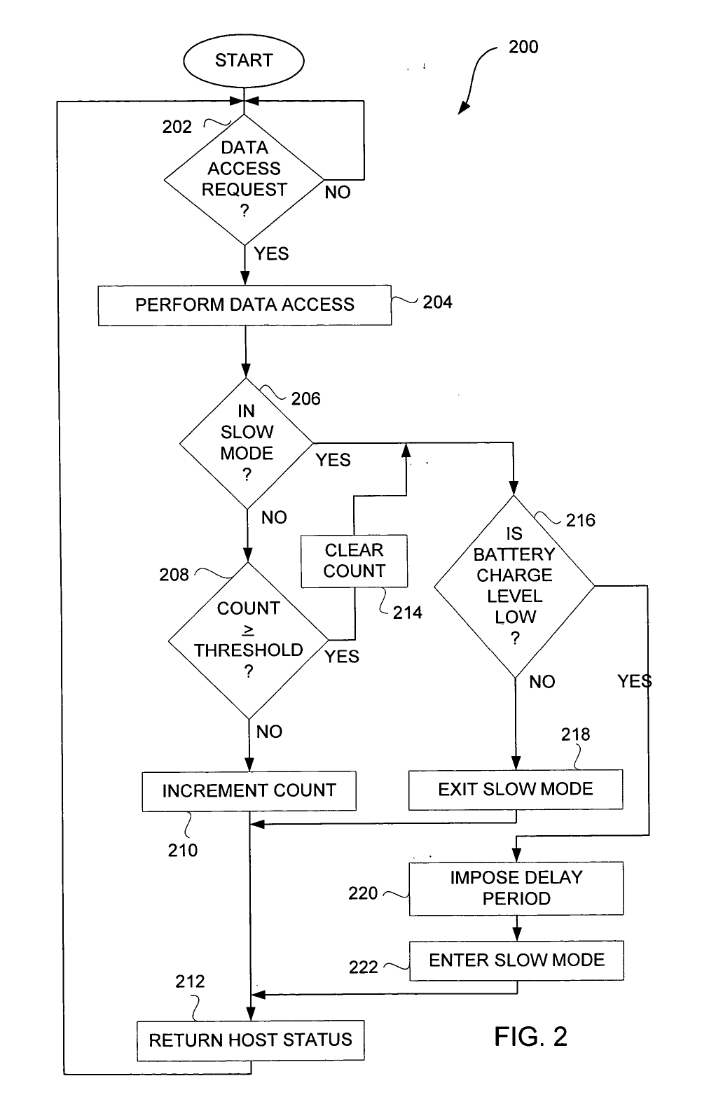

FIG. 2 is a flow diagram of a media device data access process 200 according to one embodiment of the invention. The media device data access process 200 is, for example, performed by a media device, such as a media player.

The media device data access process 200 begins with a decision 202 that determines whether a data access request has been received. As an example, the data access request can seek to access a disk storage device within the media device. When the decision 202 determines that a data access request has not yet been received, the media device data access process 200 awaits such a request.

Once the decision 202 determines that a data access request has been received, a data access is performed 204. Here, as an example, if the data access request was a disk access request, the disk storage device within the media device would be accessed 204 to obtain the data being requested. The access to the disk storage device may involve a read or write operation.

Next, a decision 206 determines whether the media device is in a slow mode. For example, in the slow mode, data access is performed at a reduced rate. When the decision 206 determines that the media device is not in a slow mode, a decision 208 determines whether a count exceeds a threshold. The count can refer to the count of the number of data access requests and the threshold can pertain to a predetermined value (e.g., 1000). When the decision 208 determines that the count exceeds the threshold, the count is cleared 214.

When the decision 208 determines that the count does not exceed the threshold, the count is incremented 210. Then, a host status is returned 212 to the host device. The host status informs the host device of the status of the data transfer. Following the operation 212, the media device data access process 200 returns to repeat the decision 202 and subsequent blocks so that additional data access requests can be similarly processed.

When the decision 206 determines that the media device is in the slow mode, or following the block 214 when the count exceeds the threshold, a decision 216 determines whether the battery charge level for the battery within the media device is low. When the decision 216 determines that the battery charge level is not low, then the media device exits 218 from the slow mode. In the case in which the media device is not already in the slow mode when the operation 218 is to be performed, the block 218 has no effect. Alternatively, when the decision 216 determines that the battery charge level is low, a delay period is imposed 220. In addition, the media device enters 222 the slow mode. In the case in which the media device is already in the slow mode, the operation 222 has no effect. Following the blocks 218 and 222, the media device data access process 200 also performs the operation 212 so that the host status is returned to the host computer.

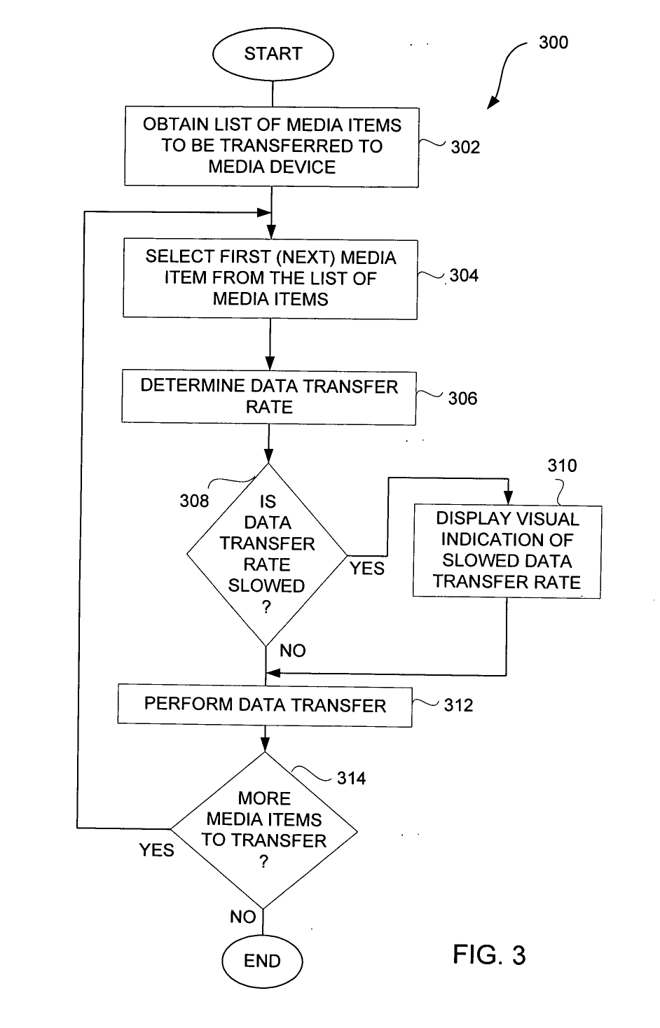

FIG. 3 is a flow diagram of a host data transfer process 300 according to one embodiment of the invention. The host data transfer process 300 is, for example, performed by a host device, such as a host computer, when interacting with a media device, such as a media player.

The host data transfer process 300 begins by obtaining 302 a list of media items to be transferred to the media device. For example, the list of media items may be those media items that reside on the host computer but do not reside on the media device. Hence, the list can be part of a synchronization process by which media items resident on the host computer are identified and then transferred to the media device.

Next, a first media item from the list of media items is selected 304. A data transfer rate is then determined 306. For example, the data transfer rate can be determined 306 to be either a normal data transfer rate or a slowed data transfer rate. Here, the host computer interacts with the media device to determine whether the data transfer rate is either normal or slowed. Thereafter, decision 308 determines whether the data transfer rate is slowed. When the decision 308 determines that the data transfer rate is slowed, a visual indication of the slowed data transfer rate can be displayed 310 at the host computer. The visual indication can inform the user of the host computer that the data transfer being performed with respect to the media device is slowed. In one implementation, the visual indicator can be automatically displayed on a display device associated with the host computer during the slowed data transfer.

On the other hand, when the decision 308 determines that the data transfer rate is not slowed, or following the operation 310 when the data transfer rate is slowed, the data transfer with respect to the media device is performed 312. After the data transfer has been performed, the host data transfer process 300, although not shown, can receive a host status from the media device informing the host that the data transfer has completed. Additionally, and also not shown, the host data transfer process 300 can also clear any indication it might have displayed with respect to the operation 310 once the data transfer has completed or has returned to its normal data transfer rate. Although the host data transfer process 300 suggests that the data transfer rate is fixed during transfer of a particular media item, in an alternative embodiment, the data transfer rate can be more frequently determined, such as for sub-portions (e.g., blocks) of a media item.

Nevertheless, following the performance 312 of the data transfer, a decision 314 determines whether there are more media items to be transferred. When the decision 314 determines that there is at least one additional media item to be transferred, the host data transfer process 300 returns to repeat the operation 304 and subsequent operations whereby a next media item from the list of media items is selected and then appropriately transferred to the media device in accordance with operations 306-312. Alternatively, once the decision 314 determines that there are no more media items to be transferred, the host data transfer process 300 is complete and ends.

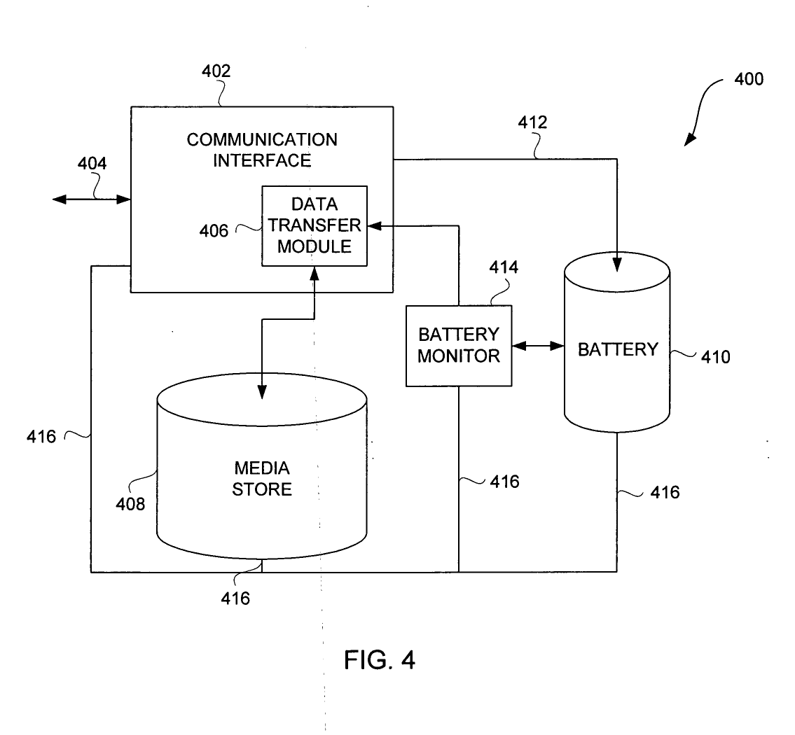

FIG. 4 is a block diagram of a media device 400 according to one embodiment of the invention. The media device 400 includes a communication interface 402 that couples to a bus connection 404. The bus connection 404 allows the media device 400 to couple to a host device (e.g., host computer). The media device 400 can receive or transmit media data over the bus connection 404. In addition, the bus connection 404 can supply power from the host device to the media device 400.

The communication interface 402 includes a data transfer module 406 that manages the transmission and/or reception of media data over the bus connection 404. The data transfer module 406 controls the transfer of media data with respect to a media store 408. During data transfer, media data is either written to or read from the media store 408. According to one embodiment of the invention, the data transfer module 406 controls the rate of data transfer so as to manage the rate of power consumption by the media device 400. Access to the media store 408 tends to consume significant amounts of power. For example, the media store 408 can be a disk data storage device, and the reading and writing of data to the media store 408 consumes substantial amounts of power. Hence, the data transfer module 406 can operate to reduce the rate at which reading or writing of media items is performed with respect to the media store 408 (and thus the average transfer rate on the bus connection 404). As a result, by slowing the data transfer rate, the rate of power consumption by the media device 400 is able to be reduced.

The media device 400 also includes a battery 410. The battery 410 can receive incoming power from a power input line 412 from the communication interface 402. The power provided on the power input line 412 is a result of the power supplied over the bus connection 404. The media device 400 also includes a battery monitor 414. The battery 410 supplies power to all of the components within the media device 400. In particular, the battery 410 outputs power on a power output line 416 that is coupled to the communication interface 402, the media store 408 and the battery monitor 414. The battery monitor 414 is able to monitor status of the battery 410. For example, the status of the battery 410 might provide an indication of battery charge level. The battery monitor 414 can then inform the data transfer module 406 of the status of the battery 410. Hence, using the status of the battery 410 (battery status), the data transfer module 406 can determine how and when to alter the rate of data transfer. For example, when the battery status indicates that the battery charge level is low (e.g., less than 25% of full capacity), then the data transfer module 406 can act to slow the rate of data transfer over the bus connection 404 (e.g., 50% of the normal data transfer rate).

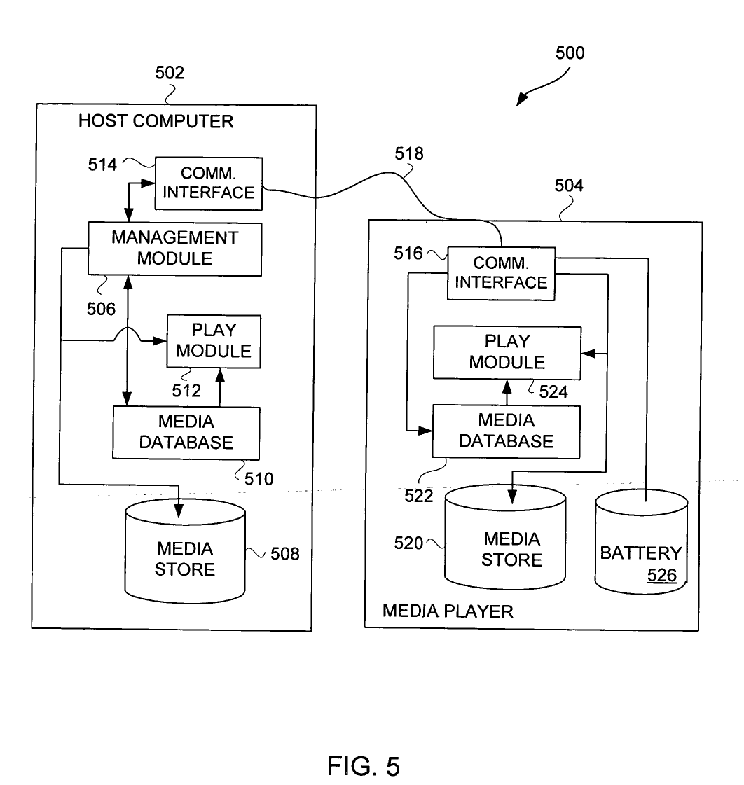

FIG. 5 is a block diagram of a media management system 500 according to one embodiment of the invention. The media management system 500 includes a host computer 502 and a media player 504. The host computer 502 is typically a personal computer. The host computer, among other conventional components, includes a management module 506 which is a software module. The management module 506 provides for centralized management of media items (and/or playlists) not only on the host computer 502 but also on the media player 504. More particularly, the management module 506 manages those media items stored in a media store 508 associated with the host computer 502. The management module 506 also interacts with a media database 510 to store media information associated with the media items stored in the media store 508.

The media information pertains to characteristics or attributes of the media items. For example, in the case of audio or audiovisual media, the media information can include one or more of: title, album, track, artist, composer and genre. These types of media information are specific to particular media items. In addition, the media information can pertain to quality characteristics of the media items. Examples of quality characteristics of media items can include one or more of: bit rate, sample rate, equalizer setting, volume adjustment, start/stop and total time.

Still further, the host computer 502 includes a play module 512. The play module 512 is a software module that can be utilized to play certain media items stored in the media store 508. The play module 512 can also display (on a display screen) or otherwise utilize media information from the media database 510. Typically, the media information of interest corresponds to the media items to be played by the play module 512.

The host computer 502 also includes a communication interface 514 that couples to a corresponding communication interface 516 within the media player 504. A connection or link 518 removeably couples the communication interfaces 514 and 516. In one embodiment, the connection or link 518 is a cable that provides a data bus, such as a FIREWIRE™ bus or USB bus, which is well known in the art.

The media player 504 also includes a media store 520 that stores media items within the media player 504. The media items being stored to the media store 520 are typically received over the connection or link 518 from the host computer 502. More particularly, the management module 506 sends all or certain of those media items residing on the media store 508 over the connection or link 518 to the media store 520 within the media player 504. Additionally, the corresponding media information for the media items that is also delivered to the media player 504 from the host computer 502 can be stored in a media database 522. In this regard, certain media information from the media database 510 within the host computer 502 can be sent to the media database 522 within the media player 504 over the connection or link 518. Still further, playlists identifying certain of the media items can also be sent by the management module 506 over the connection or link 518 to the media store 520 or the media database 522 within the media player 504.

Furthermore, the media player 504 includes a play module 524 that couples to the media store 520 and the media database 522. The play module 524 is a software module that can be utilized to play certain media items stored in the media store 520. The play module 524 can also display (on a display screen) or otherwise utilize media information from the media database 522. Typically, the media information of interest corresponds to the media items to be played by the play module 524. The media player 504 is powered by a battery 526. The battery 526 can also be charged by power supplied to the media player 504 from the host computer 502 via the connection or link 518.

Hence, in one embodiment, the media player 504 has limited or no capability to manage media items on the media player 504. However, the management module 506 within the host computer 502 can indirectly manage the media items residing on the media player 504. For example, to “add” a media item to the media player 504, the management module 506 serves to identify the media item to be added to the media player 504 from the media store 508 and then causes the identified media item to be delivered to the media player 504. As another example, to “delete” a media item from the media player 504, the management module 506 serves to identify the media item to be deleted from the media store 508 and then causes the identified media item to be deleted from the media player 504. As still another example, if changes (i.e., alterations) to characteristics of a media item were made at the host computer 502 using the management module 506, then such characteristics can also be carried over to the corresponding media item on the media player 504. In one implementation, the additions, deletions and/or changes occur in a batch-like process during synchronization of the media items on the media player 504 with the media items on the host computer 502.

In another embodiment, the media player 504 has limited or no capability to manage playlists on the media player 504. However, the management module 506 within the host computer 502, through management of the playlists residing on the host computer 502, can indirectly manage the playlists residing on the media player 504. In this regard, additions, deletions or changes to playlists can be performed on the host computer 502 and then by carried over to the media player 504 when delivered thereto.

As previously noted, synchronization is a form of media management. The ability to automatically initiate synchronization was also previously discussed. Still further, however, the synchronization between devices can be restricted so as to prevent automatic synchronization when the host computer and media player do not recognize one another.

According to one embodiment, when a media player is first connected to a host computer (or even more generally when matching identifiers are not present), the user of the media player is queried as to whether the user desires to affiliate, assign or lock the media player to the host computer. When the user of the media player elects to affiliate, assign or lock the media player with the host computer, then a pseudo-random identifier is obtained and stored in either the media database or a file within both the host computer and the media player. In one implementation, the identifier is an identifier associated with (e.g., known or generated by) the host computer or its management module and such identifier is sent to and stored in the media player. In another implementation, the identifier is associated with (e.g., known or generated by) the media player and is sent to and stored in a file or media database of the host computer.

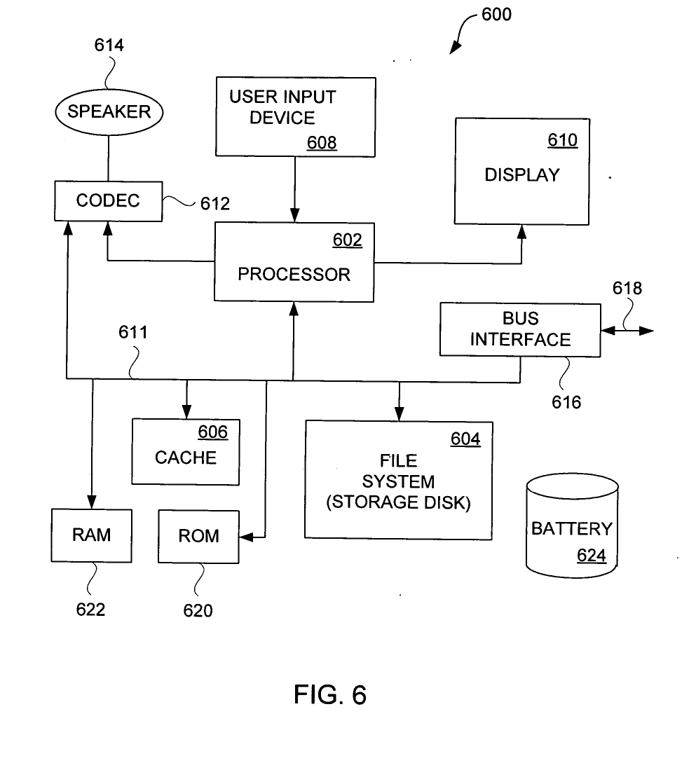

FIG. 6 is a block diagram of a media player 600 according to one embodiment of the invention. The media player 600 includes a processor 602 that pertains to a microprocessor or controller for controlling the overall operation of the media player 600. The media player 600 stores media data pertaining to media items in a file system 604 and a cache 606. The file system 604 is, typically, a storage disk or a plurality of disks. The file system 604 typically provides high capacity storage capability for the media player 600. However, since the access time to the file system 604 is relatively slow, the media player 600 can also include a cache 606. The cache 606 is, for example, Random-Access Memory (RAM) provided by semiconductor memory. The relative access time to the cache 606 is substantially shorter than for the file system 604. However, the cache 606 does not have the large storage capacity of the file system 604. Further, the file system 604, when active, consumes more power than does the cache 606. The power consumption is often a concern when the media player 600 is a portable media player that is powered by a battery (not shown). The media player 600 also includes a RAM 620 and a Read-Only Memory (ROM) 622. The ROM 622 can store programs, utilities or processes to be executed in a non-volatile manner. The RAM 620 provides volatile data storage, such as for the cache 606.

The media player 600 also includes a user input device 608 that allows a user of the media player 600 to interact with the media player 600. For example, the user input device 608 can take a variety of forms, such as a button, keypad, dial, etc. Still further, the media player 600 includes a display 610 (screen display) that can be controlled by the processor 602 to display information to the user. A data bus 611 can facilitate data transfer between at least the file system 604, the cache 606, the processor 602, and the CODEC 612.

In one embodiment, the media player 600 serves to store a plurality of media items (e.g., songs) in the file system 604. When a user desires to have the media player play a particular media item, a list of available media items is displayed on the display 610. Then, using the user input device 608, a user can select one of the available media items. The processor 602, upon receiving a selection of a particular media item, supplies the media data (e.g., audio file) for the particular media item to a coder/decoder (CODEC) 612. The CODEC 612 then produces analog output signals for a speaker 614. The speaker 614 can be a speaker internal to the media player 600 or external to the media player 600. For example, headphones or earphones that connect to the media player 600 would be considered an external speaker.

The media player 600 also includes a network/bus interface 616 that couples to a data link 618. The data link 618 allows the media player 600 to couple to a host computer. The data link 618 can also provide power to the media player 600.

Although the media items of emphasis in several of the above embodiments were audio items (e.g., audio files or songs), the media items are not limited to audio items. For example, the media item can alternatively pertain to videos (e.g., movies) or images (e.g., photos).

The various aspects, embodiments, implementations or features of the invention can be used separately or in any combination.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that power consumption in a portable media device can be regulated so that a negative charge environment is avoided. Another advantage of the invention is that protracted data transfer by a portable media device can be reliably performed even for long durations.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for transferring data to or from a portable electronic device, the portable electronic device being capable of storing data items, the portable electronic device being powered by a battery within the portable electronic device and/or a wired bus connected to a host computer, said method comprising:
evaluating a battery charge level for the battery; and
controlling a data transfer rate for data items with respect to the portable electronic device based on the battery charge level.

2. A method as recited in claim 1, wherein said controlling of the data transfer rate controls an average data transfer rate.

3. A method as recited in claim 2,
wherein said evaluating determines whether the battery charge level is low, and
wherein said controlling operates to slow the average data transfer rate when the battery charge level is low.

4. A method as recited in claim 1, wherein said evaluating determines whether the battery charge level is low.

5. A method as recited in claim 4,
wherein when the battery charge level is low, the power for the data transfer is provided completely from the host computer over the wired bus connection and not provided from the battery within the portable media device.

6. A method as recited in claim 5, wherein a portion of the power provided from the host computer over the wired bus connection is used to charge the battery so that the battery charge level can be increased.

7. A method as recited in claim 1, wherein the portable electronic device is a handheld electronic device having a data storage device that stores the data items.

8. A method as recited in claim 7, wherein the data storage device is a hard disk drive.

9. A method as recited in claim 7, wherein the data items are digital data files.

10. A method for transferring data to or from a portable media device, the portable media device being capable of storing and playing media items, the portable media device being powered by a battery within the portable media device and/or a wired bus connected to a host computer, said method comprising:
receiving a data transfer request at the portable media device from a host device, the data transfer requests transfer of at least one block of data;
performing transfer of the at least one block of data to or from the portable media player;
determining whether a battery charge level for the battery is low;
imposing a delay when said determining determines that the battery charge level is low; and
subsequently informing the host computer that the transfer of the block of data has completed.

11. A method as recited in claim 10, wherein the portable media device has a disk drive, and
wherein the data transfer request is a disk access request.

12. A method as recited in claim 10,
wherein when the battery charge level is low, the power for performing the transfer of the at least one block of data is provided completely from the host computer over the wired bus connection and not provided from the battery within the portable media device.

13. A method as recited in claim 12, wherein a portion of the power provided from the host computer over the wired bus connection is used to charge the battery so that the battery charge level can be increased while the transfer of the at least one block of data is being performed.

14. A method as recited in claim 10, wherein the portable media device is a handheld media player having a data storage device that stores the media items.

15. A method as recited in claim 14, wherein the data storage device is a hard disk drive.

16. A method as recited in claim 14, wherein the media items are audio files that can be played by the handheld media player.

17. A method for transferring data to or from a portable media device, the portable media device being capable of storing and playing media items, the portable media device being powered by a battery within the portable media device and/or a wired bus connected to a host computer, said method comprising:
receiving a disk access request;
performing a disk access to transfer a block of data to or from the portable media player;
determining whether the portable media device is currently in a slow mode for data transfer;
determining whether a count is greater than or equal to a predetermined number;
when it is determined that the portable computing device is currently in the slow mode or when the count is greater than or equal to the predetermined number, performing at least the operations of:
determining whether a battery charge level is low;
exiting the slow mode when said determining determines that the battery charge is not low;
entering the slow mode when said determining determines that the battery charge is low; and
imposing, when in the slow mode for data transfer, a delay before the transfer of a next block of data is transferred to or from the portable media player; and
informing the host computer that the transfer of the block of data has completed.

18. A method for transferring data to or from a portable media device, the portable media device being capable of storing and playing media items, the portable media device being powered by a battery within the portable media device and/or a wired bus connected to a host computer, said method comprising:
receiving a disk access request at the portable media device from a host device;
performing a disk access to transfer a block of data to or from the portable media player;
determining whether the portable media device is currently in a slow mode for data transfer;
determining whether a count is greater than or equal to a predetermined number;
incrementing the count when the count is less than the predetermined number;
clearing the count when the count is greater than or equal to the predetermined number;
when it is determined that the portable computing device is currently in the slow mode or when the count is greater than or equal to the predetermined number, performing at least the operations of:
determining whether a battery charge level for the battery is low;
exiting the slow mode when said determining determines that the battery charge is not low; and
when it is determined that the battery charge level for the battery is low, entering the slow mode unless already in the slow mode and imposing a delay before the transfer of a next block of data is transferred to or from the portable media player; and
subsequently informing the host computer that the disk access request has completed.

19. A media device, comprising:
a media store for storing media items;
a communication interface for interfacing with a host device via a cable that provides media data and power to said media device when the cable is connected between said media device and the host device; and
a battery for providing power to said media device;
wherein media data can be transferred between the host device and said media store via said communication interface, and
wherein the rate of the transfer of the media data is slowed so that the power provided via the cable to said media device is adequate to power said media device during the transfer of the media data without assistance from said battery.

20. A media device, comprising:
a media store for storing media items;
a communication interface for interfacing with a host device via a cable that provides media data and power to said media device when the cable is connected between said media device and the host device;
a battery for providing power to said media device; and
a battery monitor that monitors a battery attribute of said battery,
wherein media data can be transferred between the host device and said media store via said communication interface, and
wherein the rate of the transfer of the media data is controlled based on the battery attribute of said battery as monitored by said battery monitor.

21. A computer readable medium including at least computer program code for transferring data to or from a portable media device, the portable media device being capable of storing and playing media items, the portable media device being powered by a battery within the portable media device and/or a bus connected to a host computer, said computer readable medium comprising:
computer program code for evaluating a battery charge level for the battery; and
computer program code for controlling a data transfer rate for media items with respect to the portable media device based on the battery charge level.

22. A computer readable medium as recited in claim 21,
wherein said computer program code for evaluating determines whether the battery charge level is low, and
wherein said computer program code for controlling operates to slow the data transfer rate when the battery charge level is low.

23. A computer readable medium as recited in claim 22,
wherein when the battery charge level is low, the power for the data transfer is provided completely from the host computer over the wired bus connection and not provided from the battery within the portable media device.

24. A computer readable medium as recited in claim 23, wherein a portion of the power provided from the host computer over the wired bus connection is used to charge the battery so that the battery charge level can be increased.

25. A computer readable medium as recited in claim 24, wherein the portable media device is a handheld media player having a data storage device that stores the media items.

26. A computer readable medium as recited in claim 25, wherein the data storage device is a hard disk drive.

27. A computer readable medium as recited in claim 21, wherein the media items are audio files that can be played by the handheld media player.

28. A computer readable medium including at least computer program code for transferring data to or from a portable electronic device, the portable electronic device being capable of storing data items, the portable electronic device being powered by a battery within the portable electronic device and/or a bus connected to a host computer, said computer readable medium comprising:
computer program code for receiving a data transfer request at the portable electronic device from a host device, the data transfer requesting transfer of at least one block of data;
computer program code for performing transfer of the at least one block of data to or from the portable electronic player;
computer program code for determining whether a battery charge level for the battery is low;
computer program code for imposing a delay when said computer program code for determining determines that the battery charge level is low; and
computer program code for subsequently informing the host computer that the transfer of the block of data has completed.

29. A computer readable medium as recited in claim 28,
wherein when the battery charge level is low, the power for performing the transfer of the at least one block of data is provided completely from the host computer over the wired bus connection and not provided from the battery within the portable media device.

30. A computer readable medium as recited in claim 29, wherein a portion of the power provided from the host computer over the wired bus connection is used to charge the battery so that the battery charge level can be increased while the transfer of the at least one block of data is being performed.

31. A computer readable medium as recited in claim 28, wherein the portable electronic device comprises a disk drive, and
wherein the data transfer request is a disk access request.
